(19) United States
(12) Patent Application Publication
(10) Pub. No.: US 2025/0375894 A1
(43) Pub. Date: Dec. 11, 2025

(54) DOOR OPENING SYSTEM OF AN ENERGY TRANSFER SYSTEM

(71) Applicant: Caterpillar Inc., Peoria, IL (US)

(72) Inventors: Matthew SHERWOOD, Christchurch (NZ); Elliot MOSS, Christchurch (NZ)

(73) Assignee: Caterpillar Inc., Peoria, IL (US)

(21) Appl. No.: 18/736,190

(22) Filed: Jun. 6, 2024

(51) Int. Cl. B25J 11/00; E05F 15/00

(52) U.S. Cl. CPC B25J 11/008; E05F 15/00; E05Y 2900/518; E05Y 2900/534

(57) ABSTRACT

An energy transfer system includes a robotic system and a door opening system. The robotic system includes an end effector for enabling an energy transfer to a work machine via a receptacle access point of the work machine. The door opening system is mounted on the end effector of the robotic system. The door opening system is configured to open an access door of the receptacle access point. The door opening system includes a manipulation system for manipulating an access mechanism of the receptacle access point to allow the access door to open.

### TECHNICAL FIELD

The present disclosure relates generally to a door opening system and, for example, to a door opening system of an energy transfer system.

### BACKGROUND

Machines (e.g., that utilize an energy source other than fossil fuel, such as electricity, hydrogen, methanol, ammonia, or other sources of energy), such as vehicles or other mobile machines, that are at least partially powered by on-board energy storage systems (e.g., batteries, hydrogen fuel cells, chemical storage components, among other examples) can be environmentally-friendly alternatives to machines powered by fossil fuels. In many cases, such a machine includes an energy transfer interface that can be physically connected to an energy transfer system to allow an energy transfer from the energy transfer system to an on-board energy storage system of the machine (e.g., to replenish the on-board energy storage system). The machine can include a door that, when in a closed position, protects or shields the energy transfer interface (e.g., from environmental conditions, such as when the machine is operating and moving for an intended purpose), and that, when in an open position, allows access to the energy transfer interface (e.g., to allow a connection to the energy transfer system).

In some cases, such as when the machine is a large work machine, the energy transfer interface and the door are positioned on the machine such that a human technician cannot practically reach the door to be able to manually open the door, such as in association with an energy transfer operation. For example, the door can include a latch, or other access mechanism, that needs to be manipulated in order to cause the door to open. But often, the latch is positioned at a height that is too high for a human technician to physically reach and manipulate (e.g., without use of a ladder or a tool) to open the door. At a work site with non-uniform, changing terrain (e.g., a work site associated with an industry, such as mining or construction), setting up a ladder, staircase, or scaffolding, is often not possible. Further, using another machine, such as an elevating work platform, to enable the human technician to be lifted to access the latch of the door creates other challenges (e.g., due to the complexity involved in using the other machine), such as increased time requirements for setup and maneuvering of the other machine and the potential risk of the other machine colliding with and damaging the machine.

PCT Application Publication No. WO2024012688 (the '688 publication) discloses an end effector for an automated vehicle charging robot designed to automatically open doors of charge ports of electric vehicles and facilitate the process of plugging in charging cables, without the need for manual input or separate tools. According to the '688 publication, the end effector comprises: a connecting module that is designed to enable a connection of the end effector to a robotic arm of a charging robot; an electrical connector including a body and a plug, the plug designed to connect to a charge port and arranged at an end of the body. Additionally, per the '688 publication, an actuator protrudes from the body and is designed to actuate a door of the vehicle charge port. Furthermore, according to the '688 application, the end effector can be rotated by the robotic arm, so that the actuator can be set in position to safely actuate a charge port door of an electric vehicle, by pressing the door at a certain location.

While the end effector of the '688 publication includes an actuator to actuate a door of a vehicle charge port of an electric vehicle, the end effector itself needs to be rotated to allow the actuator to actuate the door. This rotation of the end effector can cause positioning and alignment issues for the plug that is designed to connect to the charge port. For example, in some cases, after rotation of the end effector, a subsequent connection of the plug and the charge port can be misaligned. This can result in a sub-optimal charging of the electric vehicle, such as in terms of an increased amount of time needed to charge the electric vehicle and a decreased charge level of the electric vehicle. Sub-optimal charging of the electric vehicle can also degrade a battery of the electrical vehicle, which impacts a performance and/or an operable life of the battery, and of the electric vehicle.

The door opening system of the present disclosure solves one or more of the problems set forth above and/or other problems in the art.

### SUMMARY

In some implementations, a robotic system comprises an end effector for enabling an energy transfer to a work machine via a receptacle access point of the work machine, wherein the robotic system is configured to open an access door of the receptacle access point.

In some implementations, an end effector of a robotic system includes a door opening system for opening an access door of a receptacle access point, wherein the door opening system includes at least one of: a manipulation system for manipulating an access mechanism of the receptacle access point, or a door interaction component for preventing damage to the end effector associated with opening of the access door.

In some implementations, a door opening system of an end effector of a robotic system includes a manipulation system for manipulating an access mechanism of a receptacle access point; and a door interaction component for preventing damage associated with opening of an access door of the receptacle access point.

### BRIEF DESCRIPTION OF THE DRAWINGS

FIG. 1 is a diagram of an example work machine.

FIGS. 2A-2B are diagrams of examples of a receptacle access point.

FIGS. 3A-3B are diagrams of an example energy transfer system.

FIGS. 4A-4B are diagrams of examples of an end effector of a robotic system of an energy transfer system.

FIGS. 5A-5C are diagrams of example configurations of a door opening system of an energy transfer system.

FIG. 6 is a diagram of example components of a device associated with a door opening system of an energy transfer system.

FIG. 7 is a flowchart of an example process associated with a door opening system of an energy transfer system.

### DETAILED DESCRIPTION

This disclosure relates to a door closing system of an energy transfer system that is configured to enable an energy transfer to a work machine, which is applicable to any work machine that is at least partially powered by a non-fossil-fuel-based energy storage system. The work machine may be any type of machine configured to perform operations associated with an industry such as mining, construction, farming, transportation, or any other industry.

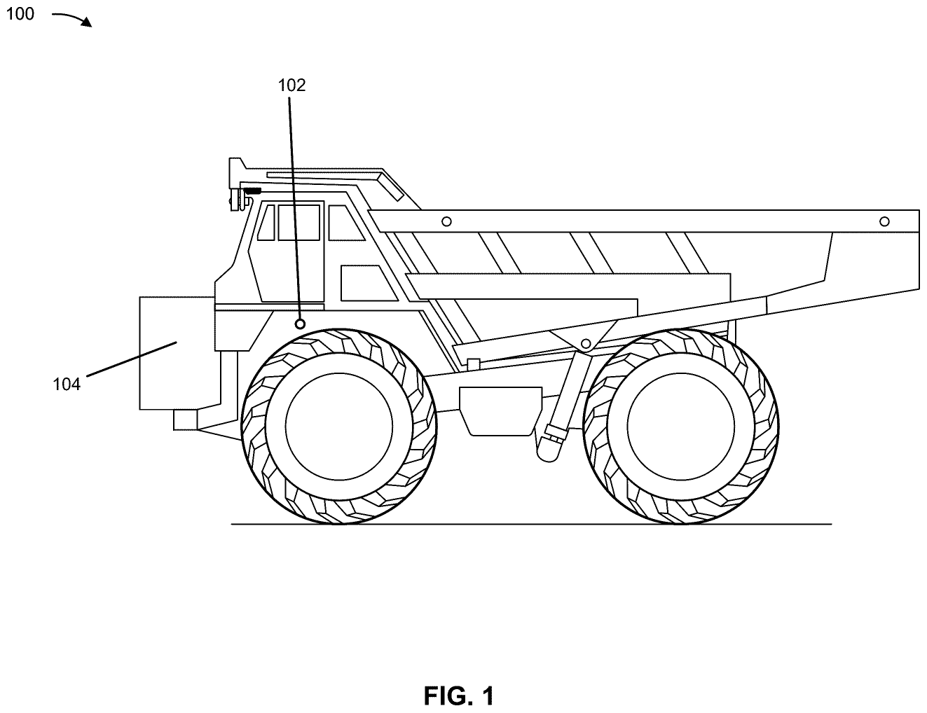

FIG. 1 is a diagram (e.g., a side-view) of an example work machine 100 described herein. The work machine 100 may be a mobile machine or vehicle, and may include a dump truck, a wheel loader, a hydraulic excavator, or another type of machine. Further, the work machine 100 may be a manned machine or an unmanned machine. The work machine 100 may be fully-autonomous, semi-autonomous, or remotely operated. As further shown in FIG. 1, the work machine 100 may include an energy storage system 102 (e.g., included within a chassis of the work machine 100) and a receptacle access point 104.

The work machine 100 may be configured to be at least partially powered by the energy storage system 102. That is, the work machine may be a machine that utilizes electricity, hydrogen, methanol, ammonia, or other sources of energy other than a fossil fuel. As a specific example, when the energy storage system 102 includes a battery that stores electricity, the work machine 100 may be a battery electric machine (BEM), a battery electric vehicle (BEV), a hybrid vehicle, a fuel cell and battery hybrid vehicle, or another machine that is at least partially powered by the battery of the energy storage system 102. The work machine 100 may include one or more engines, one or more motors, one or more conversion systems, and/or other components that are configured to convert and/or use energy stored in the energy storage system 102, to cause overall movement of the work machine 100 across a work site and/or to cause movement of individual components or systems of the work machine 100.

The receptacle access point 104 provides an energy transfer interface (e.g., a physical energy transfer interface) for the energy storage system 102. For example, the receptacle access point 104 provides an energy transfer interface that can be physically connected to an energy transfer system (e.g., the energy transfer system 300 described herein) to allow an energy transfer from the energy transfer system to the energy storage system 102 (or vice versa). The receptacle access point 104 may be located on a front of the work machine 100 (as shown), a side of the work machine 100, a back of the work machine 100, a bottom of the work machine 100, a top of the work machine 100, or at any other position on the work machine 100. The receptacle access point 104 is further described herein.

As indicated above, FIG. 1 is provided as an example. Other examples may differ from what is described in connection with FIG. 1.

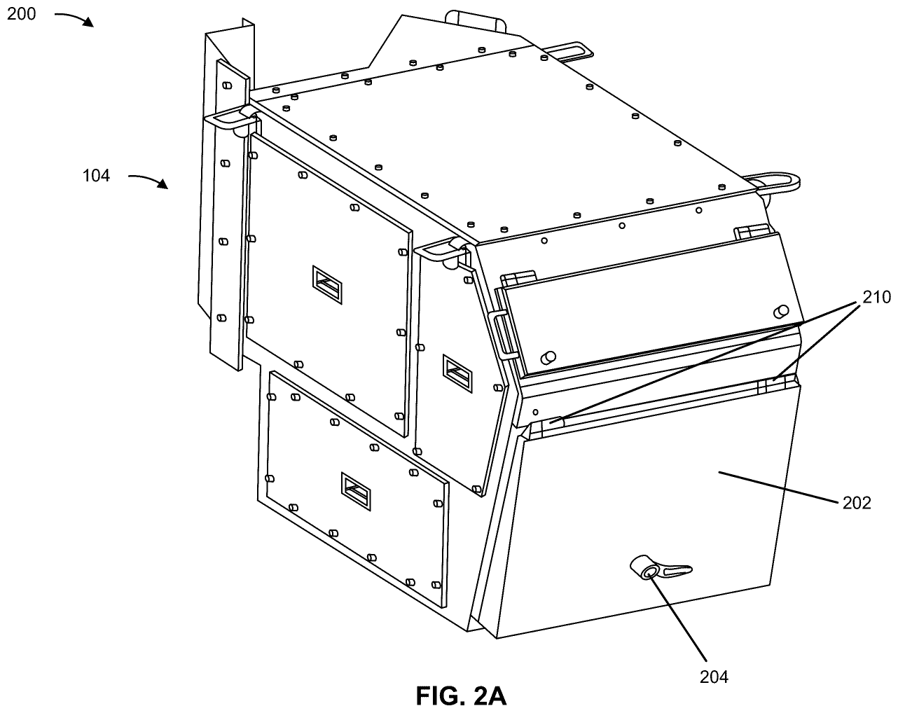

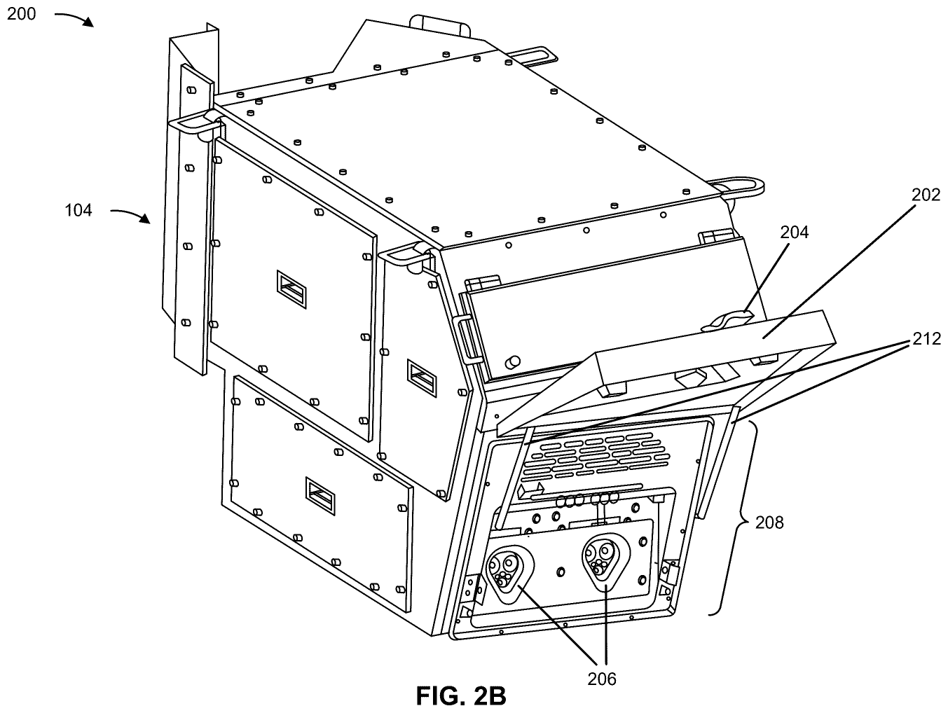

FIGS. 2A-2B are diagrams (e.g., front-angled views) of an example 200 of the receptacle access point 104 described herein. As shown in FIGS. 2A-2B, the receptacle access point 104 includes an access door 202, an access mechanism 204, and one or more receptacles 206. FIG. 2A shows the receptacle access point 104 in a closed state (e.g., when the access door 202 is in a closed position), and FIG. 2B shows the receptacle access point 104 in an open state (e.g., when the access door 202 is in an open position).

The access door 202 comprises a metal, or other hard and/or weather resistant material, and is configured to protect internal components of the receptacle access point 104, such as an interior panel 208 of the receptacle access point 104, when in the closed position. For example, when the access door 202 is in the closed position (e.g., such that edges of the access door 202 cover a flange of the interior panel 208) the access door 202 may prevent dirt, rocks, construction debris, waste matter, moisture, or other material (e.g., present at a work site at which the work machine 100 is operating) from accessing the interior panel 208. The access door 202 is moveable. For example, the access door 202 may be moved from the closed position (e.g., shown in FIG. 2A) to the open position (e.g., shown in FIG. 2B), such as by causing the access door 202 to pivot on one or more hinges 210. The receptacle access point 104 may include one or more support components 212 (e.g., one or more stays, one or more pistons, and/or one or more pneumatic cylinders, among other examples) that facilitate opening of the access door 202 (e.g., that facilitate movement of the access door 202 from the closed position to the open position) and/or that facilitate the access door 202 remaining in the open position (e.g., by resisting any force exerted on the access door 202 that is less than a force threshold that is associated with closing the access door 202).

The access mechanism 204 may be located on the access door 202, as shown in FIGS. 2A-2B, or may be located at any other position on the receptacle access point 104. The access mechanism 204 is configured to allow the access door 202 to open (e.g., to allow the access door 202 to move from the closed position to the open position and/or to remain at the open position) when the access mechanism 204 is disengaged. Further, the access mechanism 204 is configured to allow the access door 202 to remain closed (e.g., to remain in the closed position) when the access mechanism is engaged (e.g., after the access door 202 is moved to the closed position). That is, the access mechanism 204 may lock the access door 202 in the closed position when engaged, and may unlock the access door 202 to allow the access door 202 to move to the open position when disengaged.

The access mechanism 204 is configured to be manipulatable to cause the access mechanism 204 to be engaged (e.g., to change from disengaged to engaged) or to be disengaged (e.g., to change from engaged to disengaged). For example, the access mechanism 204 may be configured to be rotated, slid, pushed, pulled, lifted, extended, and/or retracted, among other examples, to cause the access mechanism 204 to be engaged or disengaged. Accordingly, the access mechanism 204 may include a latch, a bolt, a catch, a hook, a hasp, and/or a fastener, among other examples. The access mechanism 204 may include a portion, such as a latch portion, upon which a force (e.g., a pushing force, a pulling force, or another type of force) can be applied to cause the access mechanism 204 to disengage (or, alternatively, to engage) and/or to cause the access door 202 to move from the closed position (e.g., when the access mechanism 204 is disengaged). For example, applying the force to the portion of the access mechanism 204 may cause (e.g., in associated with the access mechanism 204 disengaging, or already being disengaged) the access door 202 to release from a flange of the interior panel 208 to allow the access door 202 to open (e.g., to allow movement of the access door 202 from the closed position to the open position).

As shown in FIG. 2B, the one or more receptacles 206 may be included on the interior panel 208 of the receptacle access point 104. Each of the one or more receptacles 206 may be any type of physical component for coupling with a plug of an energy transfer system (e.g., a plug 402 of the energy transfer system 300 described herein) to enable an energy transfer from the energy transfer device to the energy storage system 102 (or vice versa). While the term “receptacles” is used herein, the one or more receptacles 206 may include plugs, ports, connectors, or any other type of physical energy transfer component.

As indicated above, FIGS. 2A-2B are provided as an example. Other examples may differ from what is described in connection with FIGS. 2A-2B.

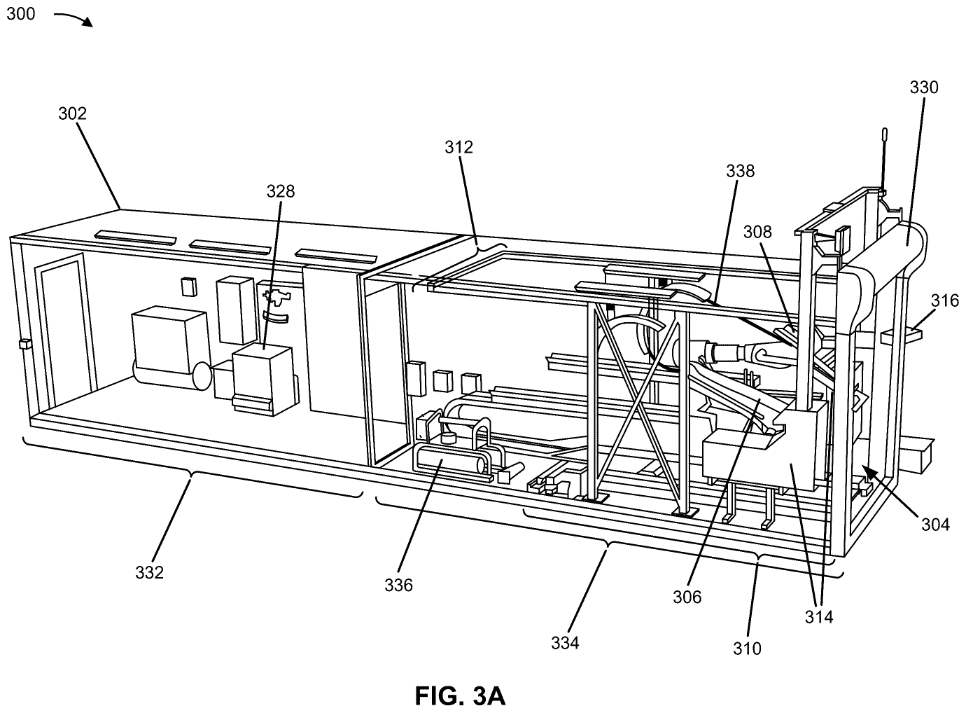

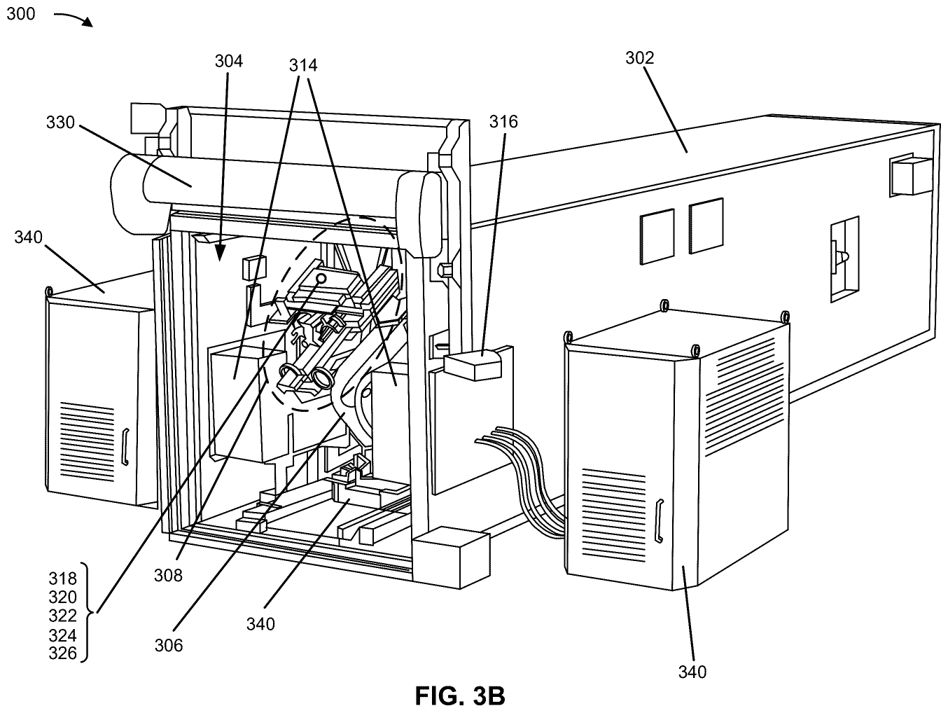

FIGS. 3A-3B are diagrams of an example energy transfer system 300. The energy transfer system 300 is configured to enable an energy transfer to and/or from the work machine 100 (e.g., to and/or from the energy storage system 102 of the work machine 100). In some implementations, the energy transfer system 300 is configured to autonomously enable the energy transfer (e.g., as further described herein), such as without any interaction with a human technician. However, other implementations include a human technician interacting with the energy transfer system 300 and, thus, the term “energy transfer system” includes any energy transfer system that is not autonomous, that is semi-autonomous (e.g., includes at least one autonomously controlled or operated system or component), or that is fully autonomous. FIG. 3A shows a side (cut-away) view of the energy transfer system 300, and FIG. 3B shows a front-angled view of the energy transfer system 300.

As shown in FIGS. 3A-3B, the energy transfer system 300 may include a housing 302 that includes a portal 304 at an end of the housing; a robotic system 306 that includes an end effector 308; a slide system 310; a cable management system 312; an energy transfer outlet system 314; a first camera system 316; a second camera system 318; a door opening system 320; a connector retention system 322; a connector protection system 324; a door closing system 326; and/or one or more controllers 328.

The housing 302 comprises a metal, or other hard and/or weather resistant material, and may have a rectangular prism shape. For example, the housing 302 may have a similar size and/or dimensions of a shipping container (e.g., with four “long” sides and two “short” sides). The housing 302 may include the portal 304 at an end of the housing 302 (e.g., instead of one of the short sides of the housing 302). The energy transfer system 300 may include an access door 330 that is configured to cover the portal 304 when closed, and to uncover the portal 304 when open. For example, the access door 330 may be a retractable door. The access door 330, when closed, may protect an interior of the housing 302, such by preventing dirt, rocks, construction debris, waste matter, moisture, or other material (e.g., present at a work site at which the work machine 100 is operating) from accessing interior of the housing 302.

As shown in FIG. 3A, the interior of the housing 302 may be divided into a first interior portion 332 of the housing 302 and a second interior portion 334 of the housing 302 (e.g., that is separated by a wall, a door, or another separator). The first interior portion 332 of the housing 302 may include the one or more controllers 328 and/or one or more other electrical components, one or more pneumatic components, and/or one or more other communication components, among other examples, that enable operation of the systems and components included in the second interior portion 334 of the housing 302.

The second interior portion 334 of the housing 302 may include the slide system 310, the cable management system 312, and the energy transfer outlet system 314. The second interior portion 334 may also include additional systems and/or components for enabling operation of the robotic system 306 and/or an energy transfer operation, such as a pressure washer system 336 and one or more energy transfer cables 338 (e.g., that are configured to transmit energy to and/or from one or more plugs of the end effector 308, such as the one or more plugs 402 described herein).

The slide system 310 is configured to move the robotic system 306, via the portal 304 of the housing 302, between an interior of the housing 302 (e.g., the second interior portion 334 of the housing 302) and an external environment (e.g., that surrounds the housing 302, such as at a work site). The cable management system 312 is configured to provide management of the one or more energy transfer cables 338. The energy transfer outlet system 314 is configured to enable a connection between the one or more energy transfer cables 338 and an external transfer dispenser system 340 (e.g., that is not included in the energy transfer system 300). Accordingly, the external transfer dispenser system 340 may provide energy to the one or more energy transfer cables 338, and thus to plugs of the end effector (e.g., the plugs 402 described herein) via the energy transfer outlet system 314.

As shown in FIGS. 3A-3B, the first camera system 316 may be mounted on an exterior (e.g., an exterior side) of the housing 302. The first camera system 316 is configured to obtain first image data associated with the receptacle access point 104 (e.g., when mounted on the work machine 100). For example, the first camera system 316 may obtain the first image data to allow the one or more controllers 328 to determine whether the receptacle access point 104 is within an engagement range of the robotic system 306 (e.g., when the robotic system 306 is moved to the external environment by the slide system 310), such as to allow the robotic system 306 to interact with the receptacle access point 104 to initiate an energy transfer operation.

As shown in FIG. 3A, the second interior portion 334 of the housing 302 may include the robotic system 306 (e.g., mounted to the slide system 310), such as when the robotic system 306 has been moved to the interior of the housing 302 by the slide system 310. The robotic system 306 is configured to enable an energy transfer to or from the work machine 100 (e.g., to or from the energy storage system 102 of the work machine 100), such as when the robotic system 306 has been moved to the external environment by the slide system 310.

In some implementations, the robotic system 306 is configured to open the access door 202 of the receptacle access point 104 (e.g., prior to commencement of an energy transfer operation enabled by coupling of the one or more receptacles 206 to one or more plugs of the end effector 308). For example, the robotic system 306 may be configured to contact the access mechanism 204 of the receptacle access point 104 when the access door 202 is in a closed position, to disengage the access mechanism 204, and to apply a force to the access mechanism 204 to allow the access door 202 to open. As another example, the robotic system 306 may be configured to contact a control element (e.g., a button, a switch, an actuator, or another type of control element) of the work machine 100 to cause the access door 202 to open (e.g., the robotic system 306 contacting the control element causes the work machine 100 to actuate opening of the access door 202). In an additional example, the robotic system 306 may be configured to send a signal (e.g., wirelessly, such as via a radio frequency (RF) communication) to the work machine 100 to cause the access door 202 to open (e.g., the robotic system 306 sending the signal causes the work machine 100 to actuate opening of the access door 202).

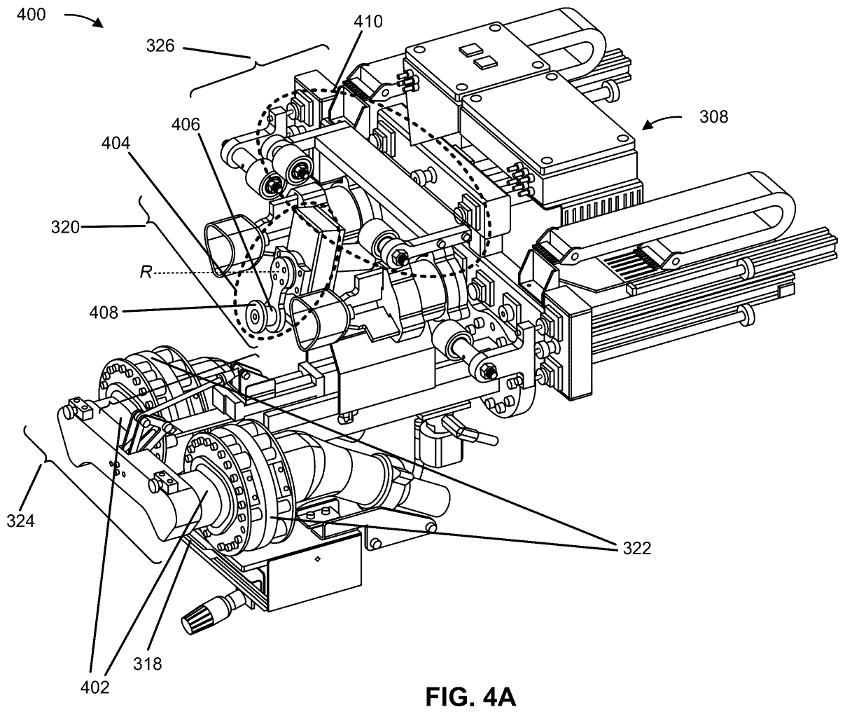

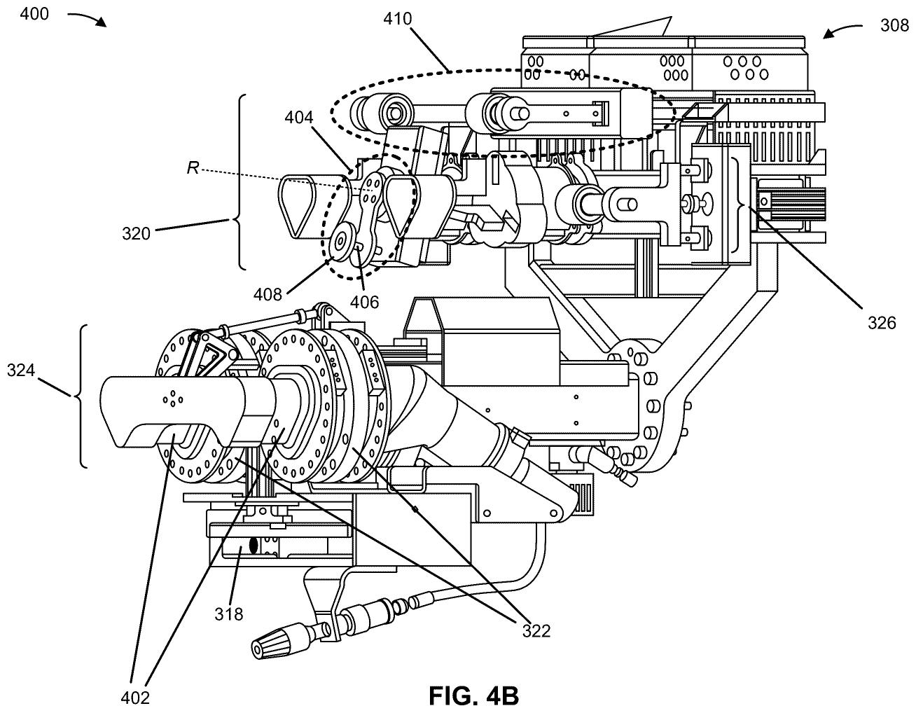

Further, the robotic system includes the end effector 308, which may include (e.g., mounted to the end effector 308) the second camera system 318, the door opening system 320, the connector retention system 322, the connector protection system 324, and/or the door closing system 326. As the illustration of the end effector 308 is too small in FIGS. 3A-3B to clearly depict the second camera system 318, the door opening system 320, the connector retention system 322, the connector protection system 324, and/or the door closing system 326, these systems and the end effector 308 are shown in greater detail in FIGS. 4A-4B.

The second camera system 318 is configured to obtain second image data associated with the access mechanism 204 of the receptacle access point 104. For example, the second camera system 318 may obtain the second image data to allow the one or more controllers 328 to identify a location of the access mechanism 204 of the receptacle access point 104, such as to allow the door opening system 320 to open the access door 202 of the receptacle access point 104 (e.g., as further described herein). Further, the second camera system 318 is configured to obtain third image data associated with the one or more receptacles 206 included in the receptacle access point 104. For example, the second camera system 318 may obtain the third image data to allow the one or more controllers 328 to identify a location of the one or more receptacles 206, such as to enable one or more plugs of the end effector 308 (e.g., the one or more plugs 402 of the end effector 308 further described herein) to couple to the one or more receptacles 206 (e.g., as further described herein) and thereby enable the energy transfer operation.

The door opening system 320 is configured to open the access door 202 of the receptacle access point 104 (e.g., based on the location of the access mechanism 204 of the receptacle access point 104 identified by the one or more controllers 328). The door opening system 320 may include a manipulation system (e.g., the manipulation system 404 described herein in relation to FIGS. 4A-4B) for manipulating the access mechanism 204 of the receptacle access point 104 to allow the access door 202 to open.

The connector retention system 322 is configured to enable coupling between the one or more plugs of the end effector 308 (e.g., the one or more plugs 402 of the end effector 308 further described herein) and the one or more receptacles 206 (e.g., to enable the energy transfer operation). The connector protection system 324 is configured to protect the one or more plugs of the end effector 308 (e.g., the one or more plugs 402 of the end effector 308 further described herein) when not coupled to the one or more receptacles 206. The door closing system 326 is configured to close the access door 202 of the receptacle access point 104 (e.g., after cessation of an energy transfer operation enabled by coupling of the one or more receptacles 206 with one or more plugs of the end effector 308).

As indicated above, FIGS. 3A-3B are provided as an example. Other examples may differ from what is described in connection with FIGS. 3A-3B.

FIGS. 4A-4B are diagrams of examples 400 of the end effector 308 of the robotic system 306 described herein. FIG. 4A shows a side-angled view of the end effector 308, and FIG. 4B shows a front-angled view of the end effector 308.

As shown in FIGS. 4A-4B, the end effector 308 includes one or more plugs 402. Each of the one or more plugs 402 may be any type of physical component for coupling with a corresponding receptacle 206 of the receptacle access point 104 to enable an energy transfer from the energy transfer system 300 to the work machine 100 (e.g., to the energy storage system 102 of the work machine 100) (or vice versa). While the term “plugs” is used herein, the one or more plugs 402 may include receptacles, ports, connectors, or any other type of physical energy transfer component.

As further shown in FIGS. 4A-4B, the end effector 308 may include (e.g., mounted to the end effector 308) the second camera system 318, the door opening system 320, the connector retention system 322, the connector protection system 324, and/or the door closing system 326. For example, as shown in FIGS. 3A-3B, the second camera system 318 may be positioned at a bottom of the end effector 308, the one or more plugs 402 may be positioned above the second camera system 318 (and the connector retention system 322 and the connector protection system 324 may be positioned in line with the one or more plugs 402), the door opening system 320 may be positioned above the one or more plugs 402, and the door opening system 320 may be positioned above the door closing system 326. While FIGS. 3A-3B show one possible configuration, some other configurations include the second camera system 318, the door opening system 320, the connector retention system 322, the connector protection system 324, and/or the door closing system 326 in different positions.

As shown in FIGS. 4A-4B, the door opening system 320 may include a manipulation system 404 for manipulating the access mechanism 204 of the receptacle access point 104 to allow the access door 202 of the receptacle access point 104 to open (e.g., when the receptacle access point 104 is within an engagement range of the robotic system 306). The manipulation system 404 may be configured to contact the access mechanism 204 of the receptacle access point 104 (e.g., when the access door 202 is in a closed position), to disengage the access mechanism 204 (e.g., by rotating the access mechanism 204), and to apply a force (e.g., a pulling force, a pushing force, or another type of force) on the access mechanism 204 to allow the access door 202 to open.

The manipulation system 404 may include a disengagement component 406 for contacting and disengaging the access mechanism 204 and a force application component 408 for applying the force to the access mechanism 204. The disengagement component 406 may be configured to rotate (e.g., around an axis R shown in FIGS. 4A-4B) to disengage the access mechanism 204. Accordingly, the disengagement component 406 may include a rotary cylinder, or another type of component that is able to rotate to disengage the access mechanism 204. For example, the access mechanism 204 may be rotatable around the axis R to allow the access mechanism 204 to engage or disengage, and the disengagement component 406 (when in contact with the access mechanism 204) may be configured to rotate around the axis R to thereby disengage the access mechanism 204 (e.g., by causing the access mechanism 204 to rotate such that the access mechanism 204 is disengaged). Additionally, or alternatively, the disengagement component 406 may be configured to slide, push, pull, lift, extend, retract, and/or move in some other way to cause the access mechanism 204 to disengage (e.g., when in contact with the access mechanism 204).

The force application component 408 is configured to apply a force (e.g., a pulling force, a pushing force, or another type of force) on the access mechanism 204 to allow the access door 202 to open. For example, the force application component 408 may be configured to engage with a portion (e.g., a latch portion, or another portion) of the access mechanism 204 and to apply the force to the portion of the access mechanism 204. Accordingly, the force application component 408 may include a catch, or another type of component that is able to engage with the portion of the access mechanism 204, to apply the force to the portion of the access mechanism 204. Applying the force to the portion of the access mechanism 204 may cause (e.g., in association with the access mechanism 204 disengaging, or already having been disengaged) the access door 202 to release from a flange of the interior panel 208 to allow the access door 202 to open (e.g., to allow movement of the access door 202 from the closed position to the open position).

As further shown in FIGS. 4A-4B, the door opening system 320 may include a door interaction component 410 for contacting the access door 202. The door interaction component 410 is configured to contact the access door 202 and to prevent the access door 202 from damaging the end effector 308 (e.g., in association with opening of the access door 202), such as after the access mechanism 204 is disengaged by the disengagement component 406 and a force (e.g., an “opening force”) is applied to the access mechanism 204 by the force application component 408. For example, the door interaction component 410 may be configured to contact and to roll along a region of the access door 202 (e.g., a region of an outside surface of the access door 202) and is thereby configured to cause a speed at which the access door 202 opens to be reduced (and, in some implementations, to be reduced such that the access door 202 stops moving). Accordingly, the door interaction component 410 may include one or more rollers (e.g., as shown in FIGS. 4A-4B), or other components that are able to roll along the region.

In this way, the door interaction component 410 may prevent the access door 202 from damaging the end effector 308 (including the door opening system 320 and other systems and components of the end effector 308). For example, the speed at which the access door 202 opens may be reduced such that there is time for the disengagement component 406 and/or the force application component 408 to move out of a path (e.g., an “opening swing path”) of the access door 202 as the access door 202 opens. As another example, the end effector 308 of the robotic system 306 may have time to move (e.g., tilt, and/or otherwise move) to allow the end effector 308 (including the door opening system 320 and other systems and components of the end effector 308) to move out of the opening swing path of the access door 202 as the access door 202 opens.

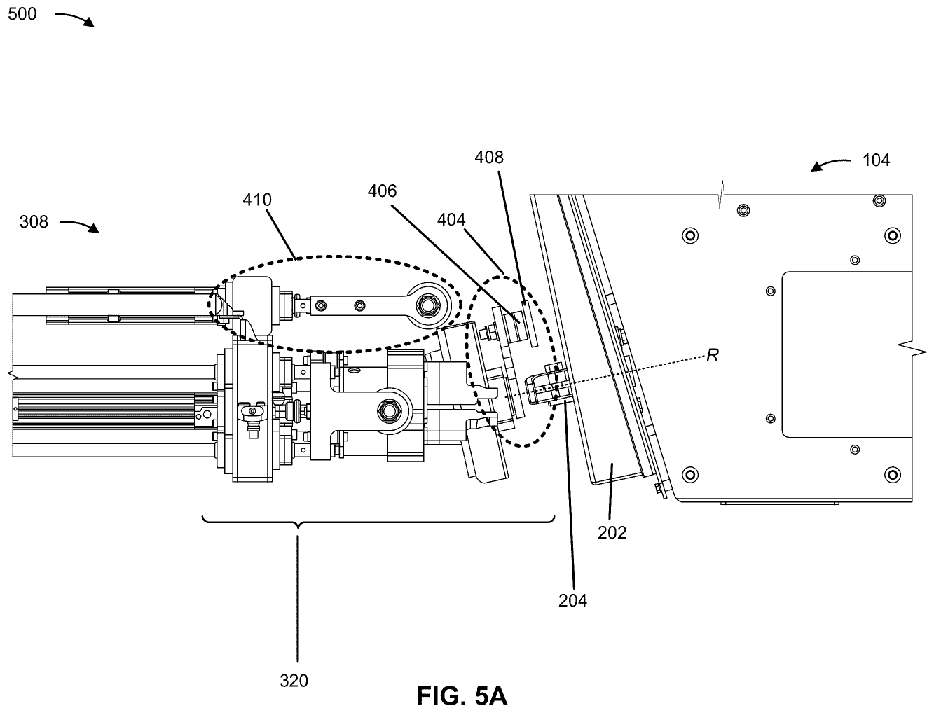

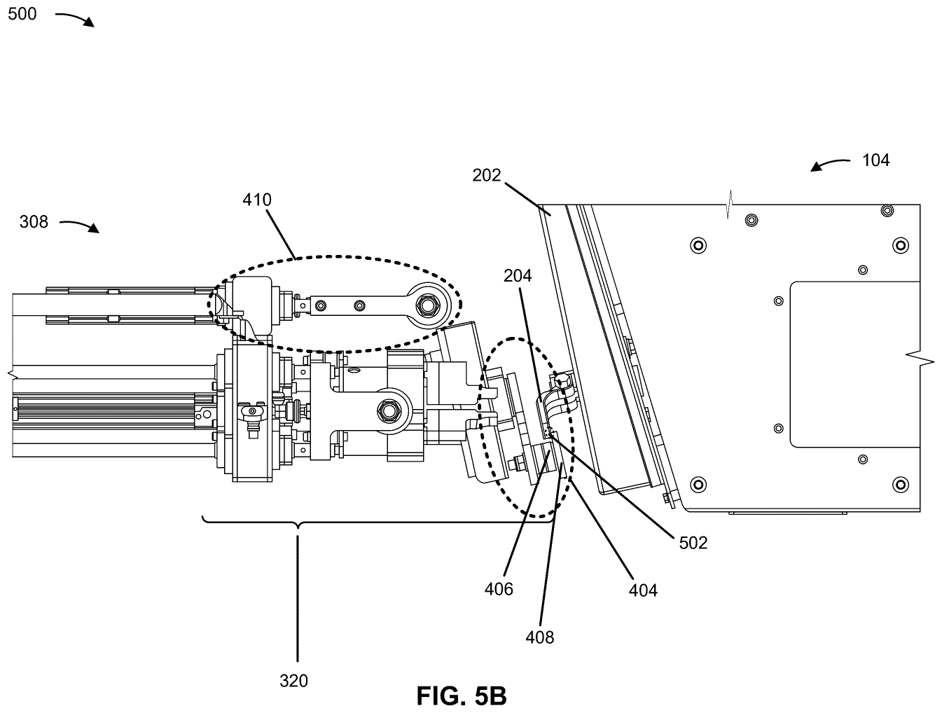

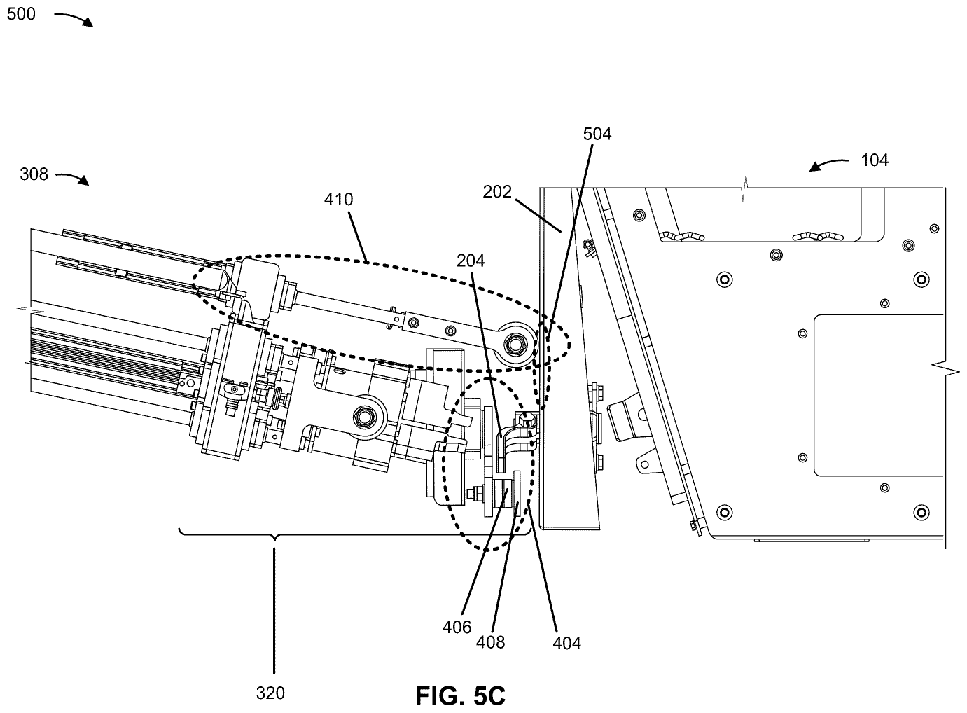

Further details related to the manipulation system 404, the disengagement component 406, the force application component 408, and the door interaction component 410 are described herein in relation to FIGS. 5A-5C.

As indicated above, FIGS. 4A-4B are provided as an example. Other examples may differ from what is described in connection with FIGS. 4A-4B.

FIGS. 5A-5C are diagrams of example configurations 500 of the door opening system 320. FIG. 5A shows a side view of the door opening system in a first configuration (e.g., when the door opening system 320 is initiating a door opening operation). As shown in FIG. 5A, the access mechanism 204 of the access door 202 of the receptacle access point 104 is engaged, which causes the access door 202 to be “locked” in the closed position. The end effector 308 may be positioned such that the disengagement component 406 of the manipulation system 404 of the door opening system 320 and the access mechanism 204 are aligned to rotate about the same axis R. Further, the end effector 308 may be positioned to allow the disengagement component 406 to contact, and therefore rotate, the access mechanism 204 around the axis R. This may cause the access mechanism 204 to disengage, and thereby causes the access door 202 to be “unlocked” in the closed position.

FIG. 5B shows a side view of the door opening system in a second configuration (e.g., after the disengagement component 406 has disengaged the access mechanism 204 and the access door 202 is unlocked in the closed position). As shown in FIG. 5B, the force application component 408 may be configured to apply a pulling force (e.g., that is applied in a right-to-left direction shown in FIG. 5B) on a portion 502 of the access mechanism 204, such as when the end effector 308 moves in the left-to-right direction. As a specific example, the force application component 408 may be configured apply a pulling force (e.g., as a catch, or a similar component) on the portion 502 (e.g., a latch portion) of the access mechanism 204. In this way, the force application component 408, by applying the pulling force, may cause the access door 202 to open (e.g., to move from the closed position).

FIG. 5C shows a side view of the door opening system in a third configuration (e.g., when the access door 202 is opening). As shown in FIG. 5C, the door interaction component may contact the access door 202 (e.g., as the access door 202 is opening) to cause a speed at which the access door opens to be reduced. For example, the door interaction component 410 may be configured to contact and to roll along a region 504 of the access door 202 to cause a speed at which the access door 202 opens to be reduced.

In this way, the door interaction component 410 may prevent the access door 202 from damaging the door opening system 320 and/or the end effector 308 of the robotic system 306. For example, the speed at which the access door 202 opens may be reduced such that there is time for the disengagement component 406 and/or the force application component 408 to move out of the opening swing path of the access door 202 and/or the end effector 308 of the robotic system 306 may have time to move (e.g., tilt, and/or otherwise move) to allow the disengagement component 406 and/or the force application component 408 to be moved out of the opening swing path of the access door 202 as the access door 202 opens.

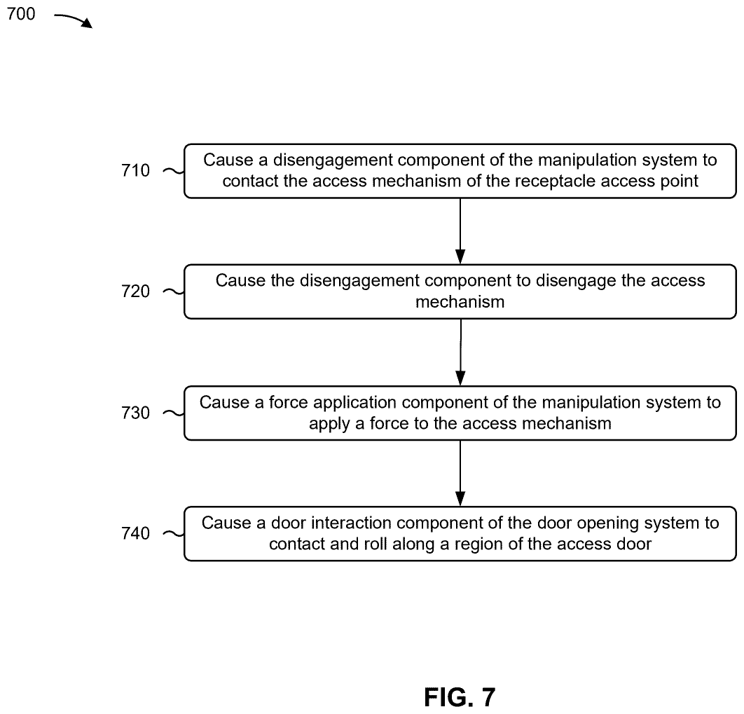

The one or more controllers 328 may control the end effector 308, the disengagement component 406, the force application component 408 of the manipulation system 404, and/or the door interaction component 410, as further described herein in relation to FIG. 7.

As indicated above, FIGS. 5A-5C are provided as an example. Other examples may differ from what is described in connection with FIGS. 5A-5C.

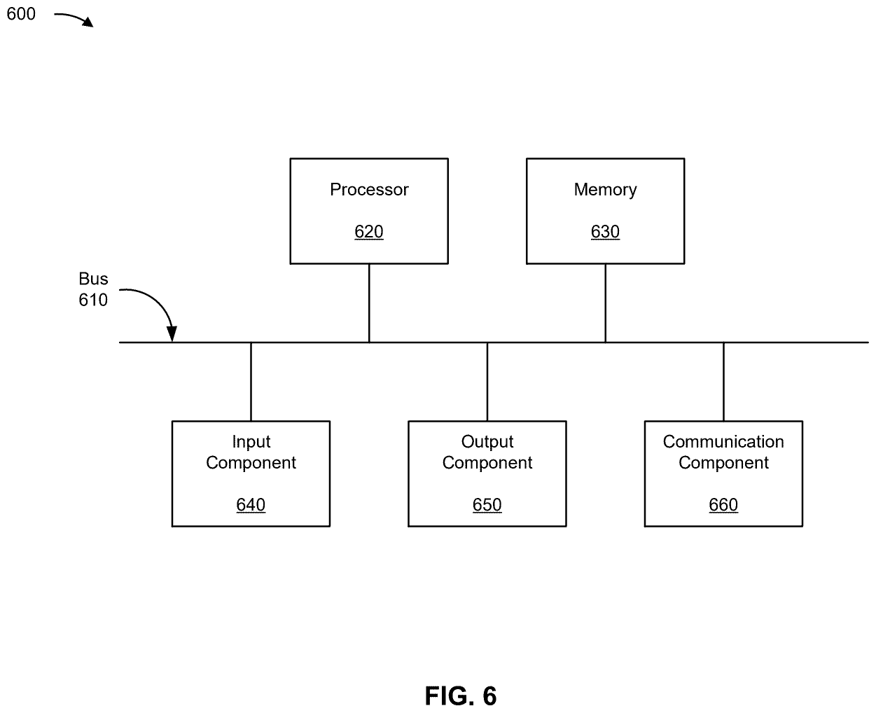

FIG. 6 is a diagram of example components of a device 600 associated with a door opening system of an energy transfer system. The device 600 may correspond to the one or more controllers 328 and/or one or more other components of the energy transfer system 300. The one or more controllers 328 and/or one or more other components of the energy transfer system 300 may include one or more devices 600 and/or one or more components of the device 600. As shown in FIG. 6, the device 600 may include a bus 610, a processor 620, a memory 630, an input component 640, an output component 650, and/or a communication component 660.

The bus 610 may include one or more components that enable wired and/or wireless communication among the components of the device 600. The bus 610 may couple together two or more components of FIG. 6, such as via operative coupling, communicative coupling, electronic coupling, and/or electric coupling. For example, the bus 610 may include an electrical connection (e.g., a wire, a trace, and/or a lead) and/or a wireless bus. The processor 620 may include a central processing unit, a graphics processing unit, a microprocessor, a controller, a microcontroller, a digital signal processor, a field-programmable gate array, an application-specific integrated circuit, and/or another type of processing component. The processor 620 may be implemented in hardware, firmware, or a combination of hardware and software. The processor 620 may include one or more processors capable of being programmed to perform one or more operations or processes described elsewhere herein.

The memory 630 may include volatile and/or nonvolatile memory. For example, the memory 630 may include random access memory (RAM), read only memory (ROM), a hard disk drive, and/or another type of memory (e.g., a flash memory, a magnetic memory, and/or an optical memory). The memory 630 may include internal memory (e.g., RAM, ROM, or a hard disk drive) and/or removable memory (e.g., removable via a universal serial bus connection). The memory 630 may be a non-transitory computer-readable medium. The memory 630 may store information, one or more instructions, and/or software (e.g., one or more software applications) related to the operation of the device 600. The memory 630 may include one or more memories that are coupled (e.g., communicatively coupled) to one or more processors (e.g., processor 620), such as via the bus 610. Communicative coupling between a processor 620 and a memory 630 may enable the processor 620 to read and/or process information stored in the memory 630 and/or to store information in the memory 630.

The input component 640 may enable the device 600 to receive input, such as user input and/or sensed input. For example, the input component 640 may include a touch screen, a keyboard, a keypad, a mouse, a button, a microphone, a switch, a sensor, a global positioning system sensor, an accelerometer, a gyroscope, and/or an actuator. The output component 650 may enable the device 600 to provide output, such as via a display, a speaker, and/or a light-emitting diode. The communication component 660 may enable the device 600 to communicate with other devices via a wired connection and/or a wireless connection. For example, the communication component 660 may include a receiver, a transmitter, a transceiver, a modem, a network interface card, and/or an antenna.

The device 600 may perform one or more operations or processes described herein. For example, a non-transitory computer-readable medium (e.g., memory 630) may store a set of instructions (e.g., one or more instructions or code) for execution by the processor 620. The processor 620 may execute the set of instructions to perform one or more operations or processes described herein. Execution of the set of instructions, by one or more processors 620, causes the one or more processors 620 and/or the device 600 to perform one or more operations or processes described herein. Hardwired circuitry may be used instead of or in combination with the instructions to perform one or more operations or processes described herein. Additionally, or alternatively, the processor 620 may be configured to perform one or more operations or processes described herein. Thus, implementations described herein are not limited to any specific combination of hardware circuitry and software.

The number and arrangement of components shown in FIG. 6 are provided as an example. The device 600 may include additional components, fewer components, different components, or differently arranged components than those shown in FIG. 6. Additionally, or alternatively, a set of components (e.g., one or more components) of the device 600 may perform one or more functions described as being performed by another set of components of the device 600.

FIG. 7 is a flowchart of an example process 700 associated with a door opening system (e.g., the door opening system 320) of an energy transfer system (e.g., the energy transfer system 300). The door opening system may include a manipulation system (e.g., the manipulation system 404). One or more process blocks of FIG. 7 may be performed by one or more controllers (e.g., the one or more controllers 328) of the energy transfer system. One or more process blocks of FIG. 7 may be performed by another device or a group of devices separate from or including the one or more controllers, such as one or more other components of the energy transfer system. Additionally, or alternatively, one or more process blocks of FIG. 7 may be performed by one or more components of device 600, such as processor 620, memory 630, input component 640, output component 650, and/or communication component 660.

As shown in FIG. 7, process 700 may include causing a disengagement component of the manipulation system to contact an access mechanism of a receptacle access point (block 710). For example, the one or more controllers may cause a disengagement component (e.g., the disengagement component 406) of the manipulation system to contact an access mechanism (e.g., the access mechanism 204) of a receptacle access point (e.g., the receptacle access point 104).

As further shown in FIG. 7, process 700 may include causing the disengagement component to disengage the access mechanism (block 720). For example, the one or more controllers may cause the disengagement component to disengage the access mechanism, such as by causing the disengagement component to rotate around an axis to disengage the access mechanism.

As further shown in FIG. 7, process 700 may include causing a force application component of the manipulation system to apply a force to the access mechanism (block 730). For example, the one or more controllers may cause, based on causing the disengagement component to disengage the access mechanism, a force application component (e.g., the force application component 408) of the manipulation system to apply a force to the access mechanism, such as by causing the force application component to engage with a portion of the access mechanism and to apply the force to the portion of the access mechanism. This may allow an access door (e.g., the access door 202) of the receptacle access point to open.

As further shown in FIG. 7, process 700 may include causing a door interaction component of the door opening system to contact and roll along a region of the access door (block 740). For example, the one or more controllers may cause a door interaction component (e.g., the door interaction component 410) of the door opening system to contact and roll along a region of the access door. This may cause a speed at which the access door opens to be reduced, which prevents damage associated with opening of the access door of the receptacle access point (e.g., to the door opening system).

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

### INDUSTRIAL APPLICABILITY

The disclosed door opening system is used to open an access door of a receptacle access point of a work machine. Thus, the door opening system eliminates a need for a human technician to interact with the access door in order to open the access door. For example, the door opening system includes a manipulation system for manipulating the access mechanism of the receptacle access point to allow the access door to open. The manipulation system is configured to contact the access mechanism of the receptacle access point when the access door is in a closed position, to disengage the access mechanism, and to apply a force to the access mechanism to allow the access door to open. For example, the manipulation system includes a disengagement component that is configured to contact and to disengage the access mechanism, and a force application component that is configured to apply a force to the access mechanism to allow the access door to open. The door opening system also includes a door interaction component that is configured to contact the access door and to prevent the access door from damaging the door opening system (and an end effector of a robotic system, upon which the door opening system may be mounted) in association with opening of the access door.

In this way, the door opening system enables automatic opening of an access door of a receptacle access point of a work machine. Accordingly, when an access mechanism of the access door is in an unreachable position (e.g., at a height that is too high for a human technician to reach), other tools or mechanisms (e.g., ladders, staircases, scaffolding, elevating work platforms, among other examples) are not needed to assist (e.g., the human technician) in reaching the access mechanism. Further, no extra time is required to setup and maneuver another machine to facilitate opening the door, and a potential risk of damaging the work machine by operating the other machine is eliminated. Additionally, because the door opening system is part of an energy transfer system that facilitates an energy transfer to (or from) the work machine, the door opening system is able to open the access door prior to initiation of the energy transfer, regardless of the terrain and environmental conditions at the work site (which would not otherwise be possible when a human technician is needed to the open the access door at a work site with particular inhospitable conditions).

What is claimed is:

1. A robotic system comprising:
an end effector for enabling an energy transfer to a work machine via a receptacle access point of the work machine,
wherein the robotic system is configured to open an access door of the receptacle access point.

2. The robotic system of claim 1, wherein the robotic system is configured to contact an access mechanism of the receptacle access point when the access door is in a closed position, to disengage the access mechanism, and to apply a force to the access mechanism to allow the access door to open.

3. The robotic system of claim 1, wherein the robotic system is configured to contact a control element of the work machine to cause the access door to open.

4. The robotic system of claim 1, wherein the robotic system is configured to send a signal to the work machine to cause the access door to open.

5. The robotic system of claim 1 further comprising:
a door opening system mounted on the end effector of the robotic system, wherein:
the door opening system includes a manipulation system for manipulating an access mechanism of the receptacle access point to allow the access door to open.

6. The robotic system of claim 5, wherein:
the manipulation system is configured to contact the access mechanism of the receptacle access point when the access door is in a closed position, to disengage the access mechanism, and to apply a force to the access mechanism to allow the access door to open.

7. The robotic system of claim 5, wherein:
the manipulation system includes a disengagement component that is configured to contact and to disengage the access mechanism.

8. The robotic system of claim 5, wherein:
the manipulation system includes a force application component that is configured to apply a force to the access mechanism to allow the access door to open.

9. The robotic system of claim 8, wherein:
the force application component is further configured to engage with a latch portion of the access mechanism and to apply the force to the latch portion of the access mechanism.

10. The robotic system of claim 5, wherein:
the door opening system further includes a door interaction component that is configured to contact the access door and to prevent the access door from damaging the end effector of the robotic system in association with opening of the access door.

11. The robotic system of claim 10, wherein:
the door interaction component is further configured to contact and to roll along a region of the access door to cause a speed at which the access door opens to be reduced.

12. The robotic system of claim 5, further comprising one or more controllers configured to:
cause a disengagement component of the manipulation system to contact the access mechanism of the receptacle access point;
cause the disengagement component to disengage the access mechanism; and
cause, based on causing the disengagement component to disengage the access mechanism, a force application component of the manipulation system to apply a force to the access mechanism.

13. The robotic system of claim 12, wherein the one or more controllers are further configured to:
cause a door interaction component of the door opening system to contact and roll along a region of the access door.

14. An end effector of a robotic system, comprising:
a door opening system for opening an access door of a receptacle access point, wherein the door opening system includes at least one of:
a manipulation system for manipulating an access mechanism of the receptacle access point, or
a door interaction component for preventing damage to the end effector associated with opening of the access door.

15. The end effector of the robotic system of claim 14, wherein:
the manipulation system is configured to disengage the access mechanism and to apply a force to the access mechanism to allow the access door to open.

16. The end effector of the robotic system of claim 14, wherein:
the manipulation system includes a disengagement component that is configured to disengage the access mechanism.

17. The end effector of the robotic system of claim 14, wherein:
the manipulation system includes a force application component that is configured to apply a force to the access mechanism.

18. A door opening system of an end effector of a robotic system, comprising:
a manipulation system for manipulating an access mechanism of a receptacle access point; and
a door interaction component for preventing damage associated with opening of an access door of the receptacle access point.

19. The door opening system of claim 18, wherein the manipulation system is configured to disengage the access mechanism to allow the access door to open.

20. The door opening system of claim 18, wherein the door interaction component is configured to cause a speed at which the access door opens to be reduced.
